(19) United States
(12) Patent Application Publication
(10) Pub. No.: US 2013/0022481 A1
(43) Pub. Date: Jan. 24, 2013

(54) MAGNETIC ROTOR AND ROTARY PUMP HAVING A MAGNETIC ROTOR

(71) Applicants: Reto Schöb, Rudolfstetten (CH); Thomas Eberle, Winterthur (CH); Natale Barletta, Zurich (CH)

(72) Inventors: Reto Schöb, Rudolfstetten (CH); Thomas Eberle, Winterthur (CH); Natale Barletta, Zurich (CH)

(73) Assignee: Levitronix GmbH, Zurich (CH)

(21) Appl. No.: 13/554,826

(22) Filed: Jul. 20, 2012

(30) Foreign Application Priority Data
Jul. 20, 2011 (EP) 11174669.9

(51) Int. Cl. H02K 1/27; F04B 9/00

(52) U.S. Cl. 417/420; 310/156.01

(57) ABSTRACT

The invention relates to a magnetic rotor (1) for a rotary pump (2), wherein the rotor (1) can be driven and levitated in a magnetically contactless manner in a pump housing (4) within a stator (5) of the rotary pump (2) for conveying a fluid (3) and the rotor (1) is encapsulated by means of an outer encapsulation (6) including a fluorinated hydrocarbon. In accordance with the invention, the rotor (1) includes a permanent magnet (8) sheathed by a metal jacket (7) within the encapsulation (6), with the metal jacket (7) including at least one metal from the group of elements composed of tantalum, niobium, zirconium, titanium, hafnium, gold, platinum, palladium, osmium, iridium, ruthenium and rhodium. The invention further relates to plant components, in particular to a rotary pump (2) having a magnetic rotor (1).

The invention relates to a magnetic rotor for a rotary pump as well as to plant components, in particular to a rotary pump having a magnetic rotor in accordance with the preamble of the independent claims 1 and 7.

Magnetically levitated rotary pumps have established themselves in the art for specific applications in which an impeller is levitated in a floating manner by magnetic forces in the interior of a preferably completely closed pump housing and is driven by a rotating field which is generated by a stator frequently arranged outside the pump housing. Such pumps are in particular advantageous for such applications in which the fluid to be conveyed may not be contaminated, for example for conveying biological liquids such as blood or very pure liquids such as ultrapure water.

In addition, such rotary pumps are suitable for conveying aggressive liquids which would destroy mechanical bearings in a short time. Such rotary pumps are therefore particularly preferably used in the semiconductor industry, for example for conveying mechanically aggressive fluids in the processing of a surface of semiconductor wafers. Chemomechanical polishing processes (CMP, chemomechanical planarization) can be named as an important example here. In such processes, a suspension, usually called a slurry, of typically very fine solid particles and a liquid is applied to a rotating wafer and there serves for the polishing or lapping of the very fine semiconductor structures. Another example is the application of photoresist to the wafer or the roughening of surfaces of computer hard disks to prevent an adhesion of the writing/reading heads by adhesion forces, that is, for example, by Van der Waals forces.

Magnetically levitated rotary pumps are also preferably used in practice for other highly aggressive substances. Thus, for example, in semiconductor production for pumping very highly aggressive chemicals such as sulfuric acid (H₂SO₄) which frequently also have to be provided at elevated temperatures, e.g. at 150° C. to 200° C. or even higher. Another typical, very aggressive acid is phosphoric acid (H₃PO₄) which has to be reliably pumped at temperatures up to 160° or even higher in specific applications. However, also hydrochloric acid, (HCl), hydrofluoric acid (HF), nitric acid (HNO₃), acetic acid (CH₃COOH) or ammonium fluoride (NH₄F₂). In this respect, mixtures are also frequently used, e.g. of sulfuric acid and ozone (H₂SO₄ with O₃), sulfuric acid with hydrogen peroxide (H₂SO₄ with H₂O₂) or, for example, sulfuric acid with hydrofluoric acid and nitric acid (H₂SO₄ with HF and HNO₃).

It is known in this respect that specific fluorinated hydrocarbons show a certain resistance to chemically aggressive substances, in particular to the previously named acids. It is therefore likewise known e.g. to provided rotors of bearingless pumps with encapsulations of fluorinated hydrocarbons to protect the permanent magnet disposed in the interior of the rotor as much as possible from the damaging influences of the aggressive acids or acid mixtures.

However, the fluorinated hydrocarbons very frequently do not form any sufficient barrier against gaseous components of the chemicals. An encapsulation from a fluorinated hydrocarbon thus e.g. only has a very restricted barrier effect against ozone (O₃) which can be contained in substantial quantities e.g. in a mixture to be pumped of sulfuric acid and ozone (H₂SO₄ with O₃).

If e.g. ozone diffuses in a sufficient quantity through the encapsulation of fluorinated hydrocarbon to the permanent magnet in the interior of the rotor, this can result in very serious damage to the permanent magnet in the rotor; the permanent magnet can e.g. absolutely swell up and, in the worst case, can actually burst the rotor.

It is self-explanatory that these negative effects are hugely amplified at elevated temperatures, not least because, as generally known, the diffusion processes are increasingly hugely accelerated at an elevated temperature.

In contrast, substances which form a better diffusion barrier are very frequently not resistant to extremely aggressive acids, above all not at an elevated temperature. If it is therefore attempted to use rotor encapsulations from a material other than fluorinated hydrocarbons, these encapsulations are very rapidly attacked by the aggressive acids; the material of the encapsulation can be partly dissolved or released by the acids and then moves as an impurity into the fluid to be pumped and can develop a damaging effect at another point in the process.

If an encapsulation contains metal, for example, metal ions can be brought into solution by the acids and can then have effects on subsequent processes as components of the fluid to be pumped. This can e.g. have almost catastrophic consequences in applications in the semiconductor industry since the dissolved metal ions can, for example change the doping of the semiconductors to be treated in an uncontrolled manner even at very low concentrations in the fluid and in the worst case can thus make the semiconductor products completely unusable.

Analog problems can naturally also occur with respect to the pump housing. If e.g. the inner surfaces of the pump housing are protected by means of a layer of fluorinated hydrocarbons, gaseous components can still diffuse through which then destroy the stator over time.

It is therefore an object of the invention to provide a magnetic rotor for a rotary pump in which a permanent magnet provided in the interior of the rotor is protected from the damaging effects of liquid and gaseous substances or substances of a fluid to be pumped dissolved in the form of ions so that the rotor has to be replaced less frequently. In addition, a rotary pump, in particular a canned motor pump, should be provided by the invention which, analog to the rotor in accordance with the invention, is sufficiently protected from the previously mentioned damaging influences known from the prior art. In this respect, in particular a sufficient protection from aggressive acids having gaseous components should be provided, also for use at high temperatures.

The subject matters of the invention satisfying these objects are characterized by the features of the independent claims 1 and 7.

The dependent claims relate to particularly advantageous embodiments of the invention.

The invention thus relates to a magnetic rotor for a rotary pump, wherein the rotor can be driven and levitated in a magnetically contactless manner in a pump housing within a stator of the rotary pump for conveying a fluid and the rotor is encapsulated by means of an outer encapsulation including a fluorinated hydrocarbon. In accordance with the invention, the rotor includes a permanent magnet sheathed by a metal jacket within the encapsulation, with the metal jacket including at least one metal from the group of elements composed of tantalum, niobium, zirconium, titanium, hafnium, gold, platinum, palladium, osmium, iridium, ruthenium and rhodium.

The permanent magnet of the rotor of the present invention is thus doubly encapsulated. An inner metal jacket surrounds the permanent magnet of the rotor substantially completely; the permanent magnet is particularly preferably surrounded in a gastight manner by the metal jacket. The metal jacket is in turn located within an outer encapsulation made of a fluorinated hydrocarbon. In this respect, the metal jacket can preferably be directly fully encased by the encapsulation or a further material can be provided, depending on the application, between the metal jacket and the outer encapsulation, for example to match the geometry, the mass or other parameters of the rotor to specific demands. Accordingly, the permanent magnet can also be directly surrounded by the metal jacket or a further material can be located between the metal jacket and the permanent magnet which e.g. serves as a thermal compensation means for compensating different thermal expansions of the metal jacket and/or of the permanent magnet. For this purpose, a corresponding spacing in the form of a gap can naturally also simply be provided between the metal jacket and the permanent magnet.

Since the permanent magnet is doubly encapsulated by the metal jacket and the outer encapsulation, the permanent magnet is simultaneously also protected, for example, against aggressive liquids such as sulfuric acid (H₂SO₄), also at elevated temperatures, e.g. at 150° C. to 200° C., or even at higher temperatures. They are screened from the permanent magnet by the outer encapsulation of fluorinated hydrocarbon. However, any gaseous component present such as ozone, which can likewise be present in the aggressive liquid chemical, is also effectively screened. The screening of any gaseous components present or also of ionic components of the acid which are not held back or are only insufficiently held back by the outer encapsulation and diffuse through the outer encapsulation into the interior of the rotor, means that they are held off at the latest by the metal jacket surrounding the permanent magnet.

It has been found in this respect that the permanent magnet of a rotor in accordance with the invention can even be reliably screened from very aggressive acids such as phosphoric acid (H₃PO₄) which has to be reliably pumped at a temperature up to 160° C. or even higher in specific applications, but also from hydrochloric acid (HCL), hydrofluoric acid (HF), nitric acid (HNO₃), acetic acid (CH₃COOH) or ammonium fluoride (NH₄F₂) and also from other chemically aggressive substances. In this respect, even mixtures, e.g. mixtures of sulfuric acid and ozone (H₂SO₄ with O₃), sulfuric acid with hydrogen peroxide (H₂SO₄ with H₂O₂) or, for example, sulfuric acid with hydrofluoric acid and nitric acid (H₂SO₄ with HF and HNO₃) or other chemically highly aggressive mixtures can be effectively screened.

The service lives of the rotors or also the service lives of plant parts which are coated in accordance with the invention with an outer layer of fluorinated hydrocarbon and a second layer disposed thereunder of a metal from the group of elements composed of tantalum, niobium, zirconium, titanium, hafnium, gold, platinum, palladium, osmium, indium, ruthenium and rhodium are decisively extended by the present invention.

In a preferred embodiment, the metal jacket of the magnetic rotor is composed only of at least one metal of the group of elements composed of tantalum, niobium, zirconium, titanium, hafnium, gold, platinum, palladium, osmium, iridium, ruthenium and rhodium. In an embodiment particularly preferred for practice, the metal jacket is composed substantially only of tantalum.

Fluorinated ethylene propylene (FEP), ethylene tetrafluoroethylene (ETFE), polytetrafluoroethylene (PTFE), perfluoroalkoxyl alkane (PFA), ethylene chlorotrifluoroethylene (ECTFE), polyvinylidene fluoride (PVDF) or a combination of different fluorinated hydrocarbons are particularly preferably considered as fluorinated hydrocarbons for the outer encapsulation. In this respect, the encapsulation of a rotor in accordance with the invention is preferably only composed of at least one of the materials polytetrafluoroethylene, perfluoroaloxyl alkane, ethylene chlorotrifluorotheylene or polyvinylidene fluoride.

In practice, the permanent magnet of the magnetic rotor is as a rule connected in a form-fitted and/or force-transmitting manner to the metal jacket so that the permanent magnet can essentially not move with respect to the remaining rotor body in the operating state. This is decisive for a safe drive of the rotor since the outer magnetic drive forces naturally engage at the permanent magnet of the rotor, whereby the rotor for pumping the fluid is set into rotation. The metal jacket is equally particularly preferably connected to the encapsulation, specifically to the plastic jacket, in a form-fitted and/or force-transmitting manner.

In this respect, a cut-out is particularly advantageously provided between the permanent magnet and the metal jacket so that the metal magnet can be welded without impairment of the permanent magnet, which will be explained in even more detail in the following with reference to the drawing.

Finally, in practice, as already mentioned above, a thermal compensation means is provided, if necessary, to compensate different thermal expansions of the metal jacket and/or of the permanent magnet so that e.g. at higher temperatures no unwanted mechanical strains are induced between the metal jacket and the permanent magnet. The thermal compensation means is very frequently simply a gap, which is selected as suitably narrow, between the permanent magnet and the metal jacket so that a form-fitted and/or force-transmitting connection is still sufficiently ensured between the metal jacket and the permanent magnet despite the gap.

The invention further relates to a rotary pump including a pump housing having an inlet for supplying a fluid into the pump housing and an outlet for leading off the fluid from the pump housing, with a magnetic rotor being levitated in a contactless magnetic manner within a stator in the pump housing and the rotor being in operative communication with a drive for conveying the fluid. The rotor is in this respect encapsulated by means of an outer encapsulation including a fluorinated hydrocarbon. In accordance with the invention, the rotor includes a permanent magnet sheathed by a metal jacket within the encapsulation, with the metal jacket including at least one metal from the group of elements composed of tantalum, niobium, zirconium, titanium, hafnium, gold, platinum, palladium, osmium, iridium, ruthenium and rhodium.

To protect the stator itself from the aggressive fluid to be pumped, an inner surface of a housing wall of the pump housing can be provided with a plastic barrier made from the fluorinated hydrocarbon, with a metal barrier, e.g. in the form of a cup or of a cylinder, preferably being provided between the inner surface of the housing wall and the stator and being composed of at least one metal from the group of elements composed of tantalum, niobium, zirconium, titanium, hafnium, gold, platinum, palladium, osmium, iridium, ruthenium and rhodium so that the stator is also ideally protected in a completely analog form to the permanent magnet in the interior of the rotor from aggressive fluids to be pumped, in particular also from the already mentioned acid mixtures having gaseous components.

The metal jacket of the rotor and/or the metal barrier toward the stator, in particular of the pump housing, is in this respect composed in a special embodiment only of at least one metal of the group of elements composed of tantalum, niobium, zirconium, titanium, hafnium, gold, platinum, palladium, osmium, iridium, ruthenium and rhodium.

In this respect, the fluorinated hydrocarbon particularly advantageously includes fluorinated ethylene propylene (FEP), ethylene tetrafluoroethylene (ETFE), polytetrafluoroethylene (PTFE), perfluoroalkoxyl alkane (PFA), ethylene chlorotrifluoroethylene (ECTFE) or polyvinylidene fluoride (PVDF) or the encapsulation and/or the plastic barrier at the inner surface of the metal barrier toward the stator substantially only composed of at least one of the materials polytetrafluoroethylene, perfluoroaloxyl alkane, ethylene chlorotrifluorotheylene or polyvinylidene fluoride.

It is understood that the rotor of the rotary pump in accordance with the invention is naturally designed as already described above and a repeat detailed description of the rotor of the rotary pump in accordance with the invention is therefore superfluous at this point.

Advantageously, a bearingless motor known per se for a long time can be considered as a drive for the rotary pump of the present invention, generally in any desired embodiment, with the stator, in a particularly preferred embodiment, being designed simultaneously as a bearing stator and as a drive stator and an axial height of the rotor preferably being smaller than or equal to half a diameter of the rotor; the rotor is therefore a so-called disk-shaped rotor known per se.

The invention will be explained in more detail in the following with reference to the drawing. There are shown in a schematic representation:

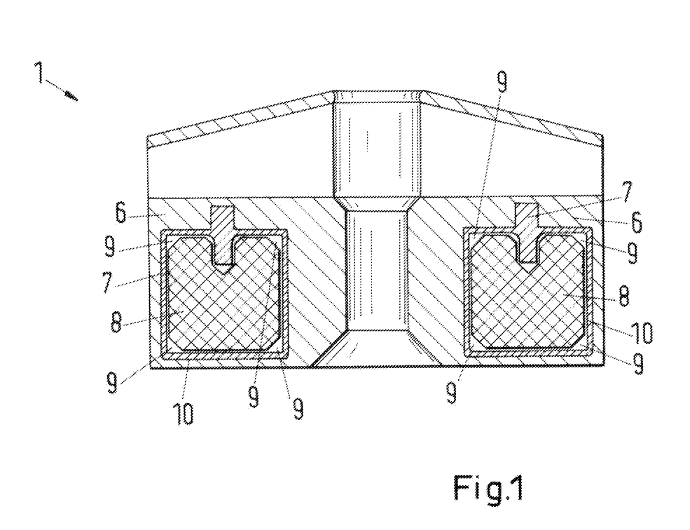

FIG. 1 an embodiment of a rotor in accordance with the invention; and

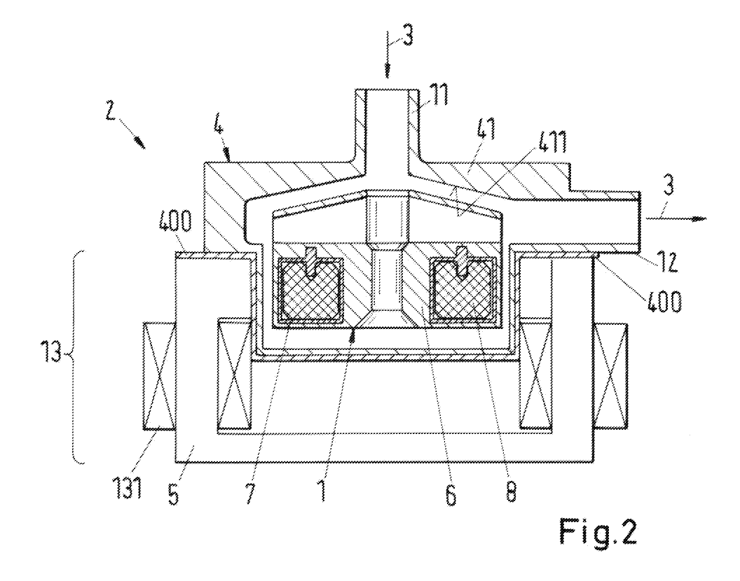

FIG. 2 a rotary pump in accordance with the invention.

FIG. 1 shows in a schematic representation, in section, a magnetic rotor 1 in accordance with the present invention.

The magnetic rotor 1 in accordance with FIG. 1 for a rotary pump 2, such as will be discussed further below in a special embodiment with reference to FIG. 2, can be driven and levitated in a magnetically contactless manner in a pump housing 4 within a stator 5 of the rotary pump 2 for conveying a fluid 3 in a manner known per se. The rotor 1 is encapsulated by means of an outer encapsulation 6 including a fluorinated hydrocarbon, with the fluorinated hydrocarbon of the encapsulation 6 e.g. including polytetrafluoroethylene, perfluoroalkoxyl alkane, ethylene chlorotrifluoroethylene or polyvinylidene fluoride. In the special example of FIG. 1, the encapsulation 6 is composed only of at least one of the aforesaid fluorinated hydrocarbons. In accordance with the invention, the rotor 1 includes a permanent magnet 8 sheathed by a metal jacket 7 within the encapsulation 6, with the metal jacket 7 including at least one metal from the group of elements composed of tantalum, niobium, zirconium, titanium, hafnium, gold, platinum, palladium, osmium, iridium, ruthenium and rhodium. In the present special embodiment, the metal jacket is composed only of tantalum, except for impurities.

As can clearly be seen from FIG. 1, the permanent magnet 8 is connected to the metal jacket 7 in a form-fitted manner, with a recess 9 in the form of a chamfer being provided at the permanent between the permanent magnet 8 and the metal jacket 7 so that the metal jacket 7 was able to be welded without impairing the permanent magnet 8 by high temperatures which are too high in the manufacture of the rotor 1. So that a penetration of gaseous components diffused through the encapsulation toward the permanent magnet 8 is prevented in the operating state, the metal jacket 7 preferably forms a gastight sheathing of the permanent magnetic 8, which is often ensured in practice in that the permanent magnet 8 is first positioned within the metal jacket 7 and the metal jacket 7 is then welded or soldered in a gastight manner.

A thermal compensation means 10, which is here simply a suitably narrow gap between the permanent magnet 8 and metal jacket 7 and serves for the compensation of different thermal expansions of the metal jacket 7 and of the permanent magnet 8, can likewise clearly be recognized in FIG. 1.

FIG. 2 finally schematically shows a section of a rotary pump 2 which is known per se and which is equipped with a rotor 1 in accordance with the present invention. The rotary pump 2 includes a pump housing 4 having an inlet 11 for supplying a fluid 3 into the pump housing 4 and having an outlet 12 for leading off the fluid 3 from the pump housing 4. The fluid 3 is in this respect, for example, a chemically aggressive acid having a portion of a gas, for example sulfuric acid with ozone. To convey the fluid 3, a magnetic rotor 1 in accordance with the invention is magnetically contactlessly levitated in a manner known per se within a stator 5 in the pump housing 4, with the rotor 1 being in magnetic operative connection with the permanent magnet 8 of the rotor 1 in a likewise known manner with a drive 13 which includes as major elements electric coils 131 and the stator 5, specifically formed by sheet iron,. The drive is here in a special embodiment a so-called bearingless motor, known per se, in which the stator 5 is simultaneously designed as a bearing stator and a drive stator. In the specific example of FIG. 2, the rotor 1 is a so-called disk-shaped rotor, with an axial height of the rotor 1 preferably being smaller than or equal to half a diameter of the rotor 1.

It is understood in this respect that the invention is not restricted to disk-shaped rotors, but that it can be used in principle for all rotor types of any desired magnetically levitated rotary machines.

in accordance with the invention, the rotor 1 is encapsulated by means of an outer encapsulation 6 made from a fluorinated hydrocarbon and the permanent magnet 8 sheathed by the metal jacket 7 is provided within the encapsulation 6. The metal jacket 7 in this respect includes at least one metal of the group of elements composed of tantalum, niobium, zirconium, titanium, hafnium, gold, platinum, palladium, osmium, iridium, ruthenium and rhodium.

A plastic barrier made from the fluorinated hydrocarbon and provided on an inner surface 411 of a housing wall 41 of the pump housing 4 is not shown in more detail for reasons of clarity, with a metal barrier in the form of a cup 400 being provided between the inner surface 411 of the housing wall 41 and the stator 5, said cup including a metal of the group of elements composed of tantalum, niobium, zirconium, titanium, hafnium, gold, platinum, palladium, osmium, iridium, ruthenium and rhodium.

As already described in detail in FIG. 1, the permanent magnet 8 is connected to the metal jacket 7 in a form-fitted and/or force-transmitting manner, with a thermal compensation means 10 in the form of a narrow gap between the metal jacket 7 and the permanent magnet 8 being provided for compensating different thermal expansions of the metal jacket 7 and of the permanent magnet 8.

It is understood that all the above-described embodiments of the invention are only to be understood as examples or by way of example and that the invention in particular, but not only, includes all suitable combinations of the described embodiments.

1. A magnetic rotor for a rotary pump (2), wherein the rotor can be driven and levitated in a magnetically contactless manner in a pump housing (4) within a stator (5) of the rotary pump (2) for conveying a fluid (3) and the rotor is encapsulated by means of an outer encapsulation (6) including a fluorinated hydrocarbon, characterized in that the rotor includes a permanent magnet (8) sheathed by a metal jacket (7) within the encapsulation (6), with the metal jacket (7) including at least one metal of the group of elements composed of tantalum, niobium, zirconium, titanium, hafnium, gold, platinum, palladium, osmium, iridium, ruthenium and rhodium.

2. A magnetic rotor in accordance with claim 1, wherein the metal jacket (7) is composed of at least one metal of the group of elements composed of tantalum, niobium, zirconium, titanium, hafnium, gold, platinum, palladium, osmium, iridium, ruthenium and rhodium.

3. A magnetic rotor in accordance with claim 1, wherein the fluorinated hydrocarbon of the encapsulation (6) includes fluorinated ethylene propylene, ethylene tetrafluoroethylene, polytetrafluoroethylene), perfluoroalkoxyl alkane, ethylene chlorotrifluoroethylene or polyvinylidene or the encapsulation (6) is preferably composed of at least one of the materials polytetrafluoroethylene, perfluoroaloxyl alkane, ethylene chlorotrifluorotheylene or polyvinylidene fluoride

4. A magnetic rotor in accordance with claim 1, wherein the permanent magnet (8) is connected to the metal jacket (7) in a form-fitted and/or force-transmitting manner.

5. A magnetic rotor in accordance with claim 1, wherein the metal jacket (7) is connected to the encapsulation (6) in a form-fitted and/or force-transmitting manner.

6. A magnetic rotor in accordance with claim 1, wherein a cut-out (9) is provided between the permanent magnet (8) and the metal jacket (7) so that the metal jacket (7) can be welded without impairing the permanent magnet (8).

7. A magnetic rotor in accordance with claim 1, wherein a thermal compensation means (10) is provided for compensating different thermal expansions of the metal jacket (7) and/or of the permanent magnet (8).

8. A rotary pump including a pump housing (4) having an inlet (11) for supplying a fluid (3) into the pump housing (4) and having an outlet (12) for leading off the fluid (3) from the pump housing (4), wherein a magnetic rotor (1) is magnetically contactlessly levitated within a stator (5) in the pump housing (4) and the rotor (1) is in operative connection with a drive (13) for conveying the fluid (3), wherein the rotor (1) is encapsulated by means of an outer encapsulation (6) including a fluorinated hydrocarbon, characterized in that the rotor (1) includes a permanent magnet (8) sheathed by a metal jacket (7) within the encapsulation (6), with the metal jacket (7) including at least one metal of the group of elements composed of tantalum, niobium, zirconium, titanium, hafnium, gold, platinum, palladium, osmium, iridium, ruthenium and rhodium.

9. A rotary pump in accordance with claim 8, wherein an inner surface (411) of a housing wall (41) of the pump housing (4) is provided with a plastic barrier made from the fluorinated hydrocarbon and a metal barrier is preferably provided between the inner surface (411) of the housing wall (41) and the stator (5) which includes at least one metal of the group of elements composed of tantalum, niobium, zirconium, titanium, hafnium, gold, platinum, palladium, osmium, iridium, ruthenium and rhodium.

10. A rotary pump in accordance with claim 8, wherein the metal jacket (7) of the rotor (1) and/or the metal barrier is composed of at least one metal of the group of elements composed of tantalum, niobium, zirconium, titanium, hafnium, gold, platinum, palladium, osmium, iridium, ruthenium and rhodium.

11. A rotary pump in accordance with claim 8, wherein the fluorinated hydrocarbon includes fluorinated ethylene propylene, ethylene tetrafluoroethylene, polytetrafluoroethylene, perfluoroalkoxyl alkane, ethylene chlorotrifluoroethylene or polyvinylidene fluoride or the encapsulation (6) and/or the plastic barrier at the inner surface (411) is preferably composed of at least one of the materials polytetrafluoroethylene, perfluoroaloxyl alkane, ethylene chlorotrifluorotheylene or polyvinylidene fluoride.

12. A rotary pump in accordance with claim 8, wherein the permanent magnet (8) is connected to the metal jacket (7) in a form-fitted and/or force-transmitting manner; and/or wherein the metal jacket (7) is connected to the encapsulation (6) in a form-fitted and/or force-transmitting manner.

13. A rotary pump in accordance with claim 8, wherein a cut-out (9) is provided between the permanent magnet (8) and the metal jacket (7) so that the metal jacket (7) can be welded without impairing the permanent magnet (8).

14. A rotary pump in accordance with claim 8, wherein a thermal compensation means (10) is provided for compensating different thermal expansions of the metal jacket (7) and/or of the permanent magnet (8).

15. A rotary pump in accordance with claim 8, wherein the drive is a bearingless motor and the stator (5) is preferably designed as a bearing stator and drive stator, with an axial height of the rotor (1) preferably being smaller than or equal to half a diameter of the rotor (1).
